(19) United States
(12) Patent Application Publication
(10) Pub. No.: US 2007/0217326 A1
(43) Pub. Date: Sep. 20, 2007

(54) Method and system for transmitting a frame in a block transmission system and for decoding the frame thereof

(75) Inventors: Sriram Rajagopal, Santa Clara, CA (US); Parikshith Sreebhashyam, Santa Clara, CA (US); Krishnamurthy Giridhar, Santa Clara, CA (US)

Correspondence Address: Beceem Communications Inc, 1st Floor, 3960 Freedom Circle, Santa Clara, CA, 95054, US

(73) Assignee: Beceem Communications, Inc.

(21) Appl. No.: 11/481,617

(22) Filed: Jul. 6, 2006

(30) Foreign Application Priority Data
Mar. 20, 2006 (IN) 389/MUM/2006

(51) Int. Cl. H04J 9/00

(52) U.S. Cl. 370/204

(57) ABSTRACT

Methods and systems for transmitting a modulated frame in a block transmission system and for decoding the modulated frame when received are provided. The block transmission system is a frequency reuse system. The transmission of a frame in a block transmission system includes modulating the frame using a modulation sequence to produce a modulated frame and transmitting the modulated frame. The modulation sequence is unknown to a receiver that will receive the modulated frame, and is representative of control information.

### RELATED APPLICATION DATA

This application claims priority to and incorporates by reference India provisional application serial number 389/MUM/2006 filed on Mar. 20, 2006, titled “Method and System for Transmitting a Frame in a Block Transmission System and for Decoding the Frame Thereof”

### BACKGROUND

The invention generally relates to block transmission systems. More particularly, the invention relates to a method and system for transmitting a frame in a block transmission system and for decoding the frame.

In Orthogonal Frequency-Division Multiplexing (OFDM) systems, training symbols such as preamble and/or mid-amble are sent from at least one transmit antenna to a receiver for enabling channel estimation. Information-carrying symbols or data symbols are then transmitted along with these training symbols in a frame as actual data sent to the receiver. In order to control or signal the receiver, control information is also sent to the receiver. However, modulation of the control information with the information-carrying symbols may reduce the amount of data that can be transmitted to the receiver.

There is therefore a need for systems and methods that provide reliable and exclusive communication channels for transmitting the control information to the receiver.

### SUMMARY

Systems and methods of an embodiment described below provide a reliable and exclusive communication channel for transmitting the control information to the receiver.

Systems and methods of an embodiment include a method and system for transmitting a modulated frame in a block transmission system. The block transmission system is a frequency reuse system. The embodiments include modulating the frame using a modulation sequence to produce a modulated frame and transmitting the modulated frame. The modulation sequence is unknown to a receiver that will receive the modulated frame, and is representative of and/or includes control information.

Further, a method and system for performing detection in a block transmission system is provided. The method includes decoding a modulated frame based on a channel impulse response of at least one training symbol of the modulated frame. The modulated frame is decoded at the receiver to detect the modulation sequence to obtain control information.

### BRIEF DESCRIPTION OF THE DRAWINGS

FIG. 1 is a flowchart for transmitting a frame in a block transmission system, in accordance with an embodiment.

FIG. 2 is a flowchart for performing detection in a block transmission system, in accordance with an embodiment.

FIG. 3 is a block diagram of a system configured to transmit a frame in a block transmission system, in accordance with an embodiment.

FIG. 4 is a block diagram of a receiver, in accordance with an embodiment.

### DETAILED DESCRIPTION OF DRAWINGS

Various embodiments described below provide a method and system (e.g. transmitter) for transmitting a frame in a block transmission system. The various embodiments also provide a method and system (e.g. receiver) for detecting the transmitted frame in a block transmission system. Examples of the block transmission system include but are not limited to Orthogonal Frequency-Division Multiplexing (OFDM), Multi-Carrier Code Division Multiple Access (MC-CDMA), Orthogonal Frequency Division Multiple Access (OFDMA), Discrete Multi-Tone (DMT) and the like. The IEEE 802.16d and 802.16e wireless Metropolitan Area Network (MAN) standards, which use OFDM-like technology, also fall in this category. In various embodiments, the block transmission system is a frequency reuse system. In an example embodiment, the block transmission system is a frequency reuse-1 system.

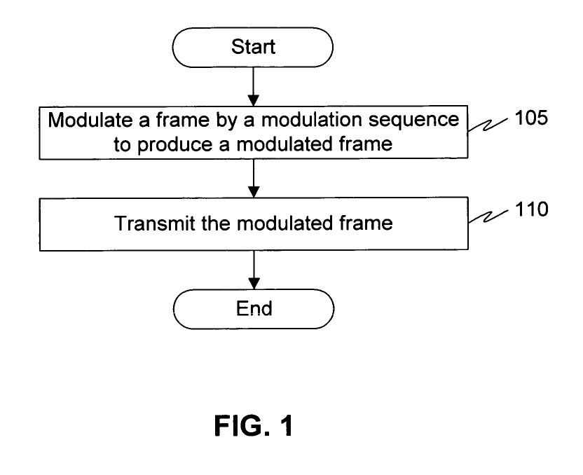

FIG. 1 is a flowchart for transmitting a frame in a block transmission system, in accordance with an embodiment. At 105, a frame that has been received is modulated by a modulation sequence to create a modulated frame. In various embodiments, the modulation sequence is unknown to a receiver that will receive the modulated frame.

In an embodiment, the modulated frame includes at least one modulated data symbol. Further, each pilot sub-carrier of a modulated data symbol is modulated by the modulation sequence. As a result, the modulation sequence may include a symbol-modulator corresponding to each modulated data symbol. In an embodiment, the modulation sequence may be a bipolar modulation sequence. For example, the symbol-modulator corresponding to a modulated data symbol can be either +1 or −1. In another embodiment, the modulation sequence may be a q-ary modulation sequence. The modulation sequence may include control information. The control information may include, but is not limited to, Automatic Repeat Request (ARQ) information, a Channel Quality Indicator Channel (CQICH) information, an Acknowledgement (ACK) signal, a Negative Acknowledgement (NACK) signal, power control information, low-bit control information and/or management information. The embodiments are however not limited to these examples of control information.

At 110, the modulated frame is transmitted to a receiver. The modulated frame may be a downlink frame or an uplink frame. In an embodiment, the same modulation sequence modulates each frame that is transmitted by a transmitter. For example, if the modulated frame is an uplink frame, the modulation sequence can correspond to a subscriber station of the block transmission system. In another example, if the modulated frame is a downlink frame, the modulation sequence can corresponds to a base station of the block transmission system.

In various embodiments, modulation of the pilot sub-carriers with the modulation sequence results in a free, exclusive and high-throughput communication channel. In an example embodiment, a 6 Kbps signaling channel is formed when binary modulation is performed on a five millisecond frame that has 30 symbols. In another example embodiment, a 12 kbps signaling channel is formed when q-ary modulation is performed on the five millisecond frame that has 30 symbols.

Further, by modulating the pilot sub-carriers by these random combinations of plus and minus ones, Co-Channel Interference (CCI) contribution may get randomized when computing channel frequency response. The modulation of an embodiment therefore can result in improved quality of channel estimation and the performance of the receiver.

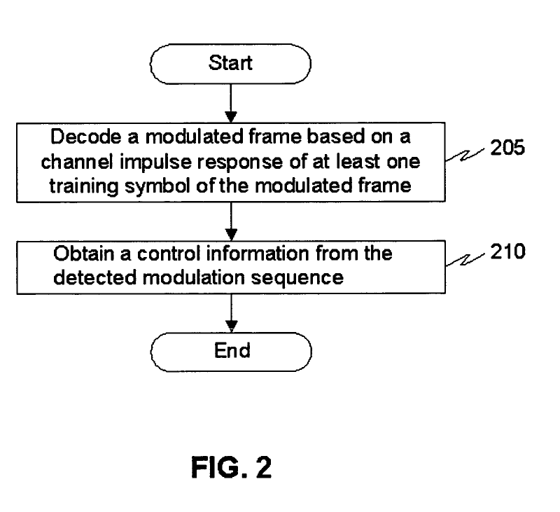

FIG. 2 is a flow chart for performing detection in a block transmission system, in accordance with an embodiment. A modulated frame is transmitted to a receiver by at least one transmit antenna of the block transmission system as described above with reference to FIG. 1. At step 205, the modulated frame is decoded by the receiver based on a channel impulse response of at least one training symbol included in the modulated frame. The training symbol may be for example, a reuse ⅓ preamble.

The modulated frame of an embodiment is decoded by obtaining a symbol-modulator corresponding to each modulated data symbol of the modulated frame and, as a result, the modulation sequence is detected. A symbol-modulator corresponding to a modulated data symbol is obtained based on the channel impulse response corresponding to at least one time index of the at least one training symbol and the channel impulse response corresponding to the at least one time index of the modulated data symbol.

In an embodiment, the channel impulse response corresponding to the at least one time index is approximately greater than or equal to a channel impulse response corresponding to remaining time indexes of the at least one training symbol. For example, the at least one time index can include a maximum time index, where the channel impulse response of the training symbol corresponding to the maximum time index is maximum with respect to channel impulse response corresponding to the remaining time indexes of the training symbol. In this example, the symbol-modulator corresponding to each data symbol can be obtained using the following equation (1):

$${\hat{p}}_{1} ( k ) = sign ( \frac{{\tilde{h}}_{1} ( {max}_{0} , k )}{{\hat{h}}_{1} ( max , 0 )} ) \qquad ( 1 )$$

where,
\hat{p}₁(k) represents a symbol-modulator corresponding to a modulated data symbol k of the modulated frame;
\tilde{h}₁(max₀,k) represents the maximum channel impulse response the corresponding a time index of the modulated data symbol k; and
ĥ₁(max,0) represents the channel impulse response corresponding to maximum time index of the training symbol.

In another embodiment, when the channels are fast fading, the maximum channel impulse response corresponding to a time index of the modulated symbol is a function of at least one channel impulse response corresponding to the maximum time index of at least one preceding modulated data symbol. For example, for obtaining the symbol-modulator of k modulated data symbol, the channel impulse response of an embodiment corresponding to the maximum time index is as follows:

ĥ₁(max,k)=f{ĥ₁(max,0),ĥ₁(max₀,1), . . . ĥ₁(max₀,k−1)} (2)

where,
ĥ₁(max,k) represents the channel impulse response corresponding to the time index of the modulated data symbol k; and
ĥ₁(max,0),ĥ₁(max₀,1), . . . ĥ₁(max₀,k−1) represent the channel impulse responses corresponding to preceding modulated data symbols. ĥ₁(max,k) can also be a function of the phase trajectory defined by channel impulse responses corresponding to the maximum time indexes of preceding modulated data symbols.

At 210, control information is obtained from the detected modulation sequence. The modulated frame can then be demodulated by removing the effect of the modulation. In an embodiment, the modulated frame can be demodulated using equation (3):

ĥ₁(k)=\hat{p}₁(k)\tilde{h}(k) (3)

where,
\hat{p}₁(k) represents the symbol-modulator corresponding to modulated data symbol k;
\tilde{h}₁(k) represents the channel impulse response corresponding to the modulated data symbol k; and
ĥ₁(k) represents the channel impulse response after removing the effect of symbol-modulator.

In another embodiment, the symbol-modulator can be obtained based on the channel impulse responses of a plurality of time indexes of the modulated data symbol k. For example, a symbol-modulator corresponding to a plurality of time indexes can be obtained, and \hat{p}₁(k) may be obtained based on a majority rule. However, the embodiments described herein are not limited to these examples of obtaining the symbol-modulator.

If the modulation sequence is a q-ary modulation sequence, then the symbol modulator may be obtained using the following equation:

$${\hat{p}}_{1} ( k ) = {arg min}_{q} \{ {\vert {s}_{q} - {\breve{p}}_{1} ( k ) \vert}^{2} \} where \\ {\breve{p}}_{1} ( k ) = \frac{{\tilde{h}}_{1} ( {max}_{0} , k )}{{\hat{h}}_{1} ( max , 0 )} \\ where , {\hat{p}}_{1} ( l ) ∈ S , with S = \{ {s}_{1} , {s}_{2} , … , {s}_{q} \} \qquad ( 4 )$$

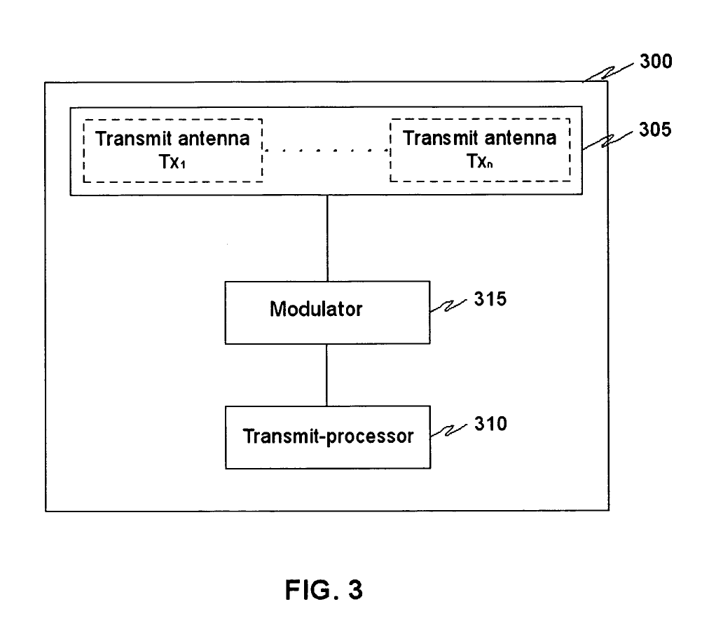

FIG. 3 is a block diagram of a system 300 for transmitting a frame in a block transmission system, in accordance with an embodiment. System 300 includes at least one transmit antenna 305 and a transmit-processor 310. At least one transmit antenna 305 transmits a modulated frame to a receiver.

Transmit-processor 310 is adaptively coupled to at least one transmit antenna 305 and is configured to modulate the frame by a modulation sequence to produce the modulated frame. Therefore, one or more components of Transmit-processor 310 (for example, a Modulator 315) of an embodiment operate in accordance with the flowchart for transmitting a frame in a block transmission system as described above with reference to FIG. 1.

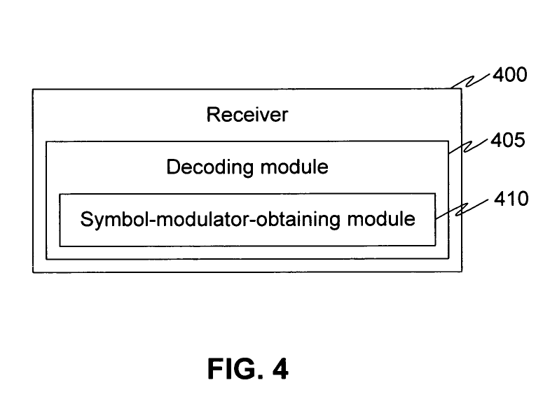

FIG. 4 is a block diagram of a receiver 400, in accordance with an embodiment. Receiver 400 includes a decoding module 405. Decoding module 405 decodes a modulated frame based on a channel impulse response of at least one training symbol of the modulated frame, where the modulated frame is modulated by at least one transmit antenna 305 with a modulation sequence. The modulated frame is decoded at the receiver 400 to detect the modulation sequence to obtain a control information.

In an embodiment, decoding module 405 includes a symbol-modulator-obtaining module 410. The symbol-modulator-obtaining module 410 obtains a symbol-modulator corresponding to each modulated data symbol of the modulated frame based on the channel impulse response corresponding to at least one time index of the at least one training symbol and channel impulse response corresponding to the at least one time index of the modulated data symbol. One or more components of Receiver 400 (e.g., Decoding module 405, Symbol-modulator-obtaining module 410) of an embodiment operate in accordance with the flowchart for performing detection in a block transmission system as described above with reference to FIG. 2.

The various embodiments described above provide a method and system for a reliable and exclusive communication channel for transmitting control information to the receiver. The modulation of the pilot sub-carriers with the modulation sequence results in a free, exclusive and high-throughput communication channel. Further, by modulating the pilot sub-carriers by the random combination of the modulation sequence, CCI contribution may get randomized when computing channel frequency response. Thus, the quality of channel estimation and the performance of the receiver may be improved.

What is claimed is:

1. A method for transmitting in a block transmission system, wherein the block transmission system is a frequency reuse system, the method comprising:
receiving a frame;
modulating the frame using a modulation sequence to generate a modulated frame; and
transmitting the modulated frame using at least one transmit antenna, the modulation sequence being unknown to a receiver that receives the modulated frame, wherein the modulation sequence represents control information.

2. The method of claim 1, wherein the modulated frame comprises at least one modulated data symbol, wherein each pilot sub-carrier of the at least one modulated data symbol is modulated by the modulation sequence.

3. The method of claim 1, wherein the modulation sequence comprises a symbol-modulator corresponding to each modulated data symbol.

4. The method of claim 1, wherein the modulation sequence is a bipolar modulation sequence.

5. The method of claim 1, wherein the modulation sequence is a q-ary modulation sequence.

6. The method of claim 1, wherein the modulated frame is a downlink modulated frame and the modulation sequence is corresponding to a base station of the block transmission system.

7. The method of claim 1, wherein the modulated frame is an uplink modulated frame and the modulation sequence is corresponding to a subscriber station of the block transmission system.

8. The method of claim 1, wherein the control information includes at least one of automatic repeat request (ARQ) information, a Channel Quality Indicator Channel (CQICH), an Acknowledgement (ACK) signal and a Negative Acknowledgement (NACK) signal.

9. A method for performing detection in a block transmission system, the detection being performed by a receiver, the block transmission system being a frequency reuse system, the method comprising:
receiving a modulated frame that is modulated by at least one transmit antenna with a modulation sequence;
decoding the modulated frame using a channel impulse response of at least one training symbol of the modulated frame, wherein the modulated frame is decoded at the receiver to detect the modulation sequence to obtain control information.

10. The method of claim 9, wherein the decoding comprises:
obtaining a symbol-modulator corresponding to each modulated data symbol of the modulated frame, wherein the symbol-modulator corresponding to a modulated data symbol is obtained based on the channel impulse response corresponding to at least one time index of the at least one training symbol and channel impulse response corresponding to the at least one time index of the modulated data symbol.

11. The method of claim 10, wherein the channel impulse response corresponding to the at least one time index of the at least one training symbol is greater than or equal to a channel impulse response corresponding to remaining time indexes of the at least one training symbol.

12. The method of claim 10, wherein the at least one time index comprise a maximum time index, wherein channel impulse response of a training symbol corresponding to the maximum time index is maximum with respect to a channel impulse response of remaining time indexes of the training symbol.

13. The method of claim 12, wherein the channel impulse response corresponding to the maximum time index of the modulated data symbol is a function of at least one channel impulse response corresponding to the maximum time index of preceding modulated data symbols.

14. A system for transmitting a frame in a block transmission system, the block transmission system being a frequency reuse system, the system comprising:
at least one transmit antenna, the at least one transmit antenna transmitting a modulated frame; and
a transmit-processor adaptively coupled to the at least one transmit antenna, wherein the transmit-processor is configured to modulate the frame using a modulation sequence to generate the modulated frame, the modulation sequence being representative of control information, wherein the modulation sequence is unknown to a receiver that will receive the modulated frame.

15. The system of claim 14, wherein the modulated frame comprises at least one modulated data symbol, wherein each pilot sub-carrier of the at least one modulated data symbol is modulated by the modulation sequence.

16. The system of claim 15, wherein the modulation sequence comprises a symbol-modulator corresponding to each modulated data symbol.

17. The system of claim 14, wherein the frequency reuse system is a frequency resuse-1 system.

18. A receiver comprising:
a decoding module coupled to a receive antenna, the decoding module decoding a modulated frame using information of a channel impulse response of at least one training symbol of the modulated frame, wherein the modulated frame is modulated by at least one transmit antenna with a modulation sequence, wherein the modulated frame is decoded at the receiver to detect the modulation sequence to obtain control information.

19. The receiver of claim 18, wherein the decoding module comprises:
an symbol-modulator-obtaining module, the symbol-modulator-obtaining module obtaining a symbol-modulator corresponding to each modulated data symbol of the modulated frame, wherein the symbol-modulator corresponding to a modulated data symbol is obtained based on the channel impulse response corresponding to at least one time index of the at least one training symbol and channel impulse response corresponding to the at least one time index of the modulated data symbol.
